(19) United States
(12) Patent Application Publication
(10) Pub. No.: US 2010/0115912 A1
(43) Pub. Date: May 13, 2010

(54) PARALLEL TURBINE ARRANGEMENT AND METHOD

(75) Inventor: Kevin Lee Worley, Easley, SC (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 12/266,897

(22) Filed: Nov. 7, 2008

(51) Int. Cl. F02C 6/00

(52) U.S. Cl. 60/39.15; 290/52; 60/772

(57) ABSTRACT

Disclosed is a parallel turbine arrangement including a compressor and a first turbine in operable communication with the compressor and a second turbine in operable communication with the compressor.

### BACKGROUND OF THE INVENTION

The subject matter disclosed herein relates to gas turbines. More particularly, the subject matter relates to a parallel gas turbine arrangement.

A typical gas turbine drives a generator that provides power to an electrical power grid. The rotational speed of the turbine is locked to a frequency of the grid. This grid frequency remains relatively constant, which in the United States is 60 hertz. During overloading conditions of the grid, however, the grid frequency begins to drop. The drop is sensed by control systems at power plants, which quickly increase power generation and supply to the grid to reduce further drops in grid frequency. During such frequency drops, however, turbines connected to the grid, decrease rotational speed and stay in sync with the grid frequency. This reduction in rotational speed of the turbine slows down a compressor that is rotationally driven by the turbine and consequently reduces airflow through the turbine. This reduced airflow through the turbine reduces efficiency and power generation by the turbine at times when it is greatly needed.

As a result of these principles, the art is always receptive to turbine arrangements with increased output, flexibility and efficiency.

### BRIEF DESCRIPTION OF THE INVENTION

According to one aspect of the invention, a parallel turbine arrangement includes a compressor and a first turbine in operable communication with the compressor, and a second turbine in operable communication with the compressor.

According to another aspect of the invention, a method for increasing operational flexibility of a power plant includes compressing fluid into a compressed fluid flow, dividing the compressed fluid flow into a first stream and a second stream, feeding a first turbine with the first stream and feeding a second turbine with the second stream.

According to yet another aspect of the invention, a parallel turbine arrangement includes a compressor having a compressor discharge flow divided into a plurality of streams, and each of the plurality of streams is in operable communication with a separate turbine.

### BRIEF DESCRIPTION OF THE DRAWING

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 depicts a schematic view of a parallel turbine arrangement disclosed herein.

### DETAILED DESCRIPTION OF THE INVENTION

A detailed description of the hereinafter described embodiments of the disclosed apparatus and method are presented herein by way of exemplification and not limitation with reference to the Figure.

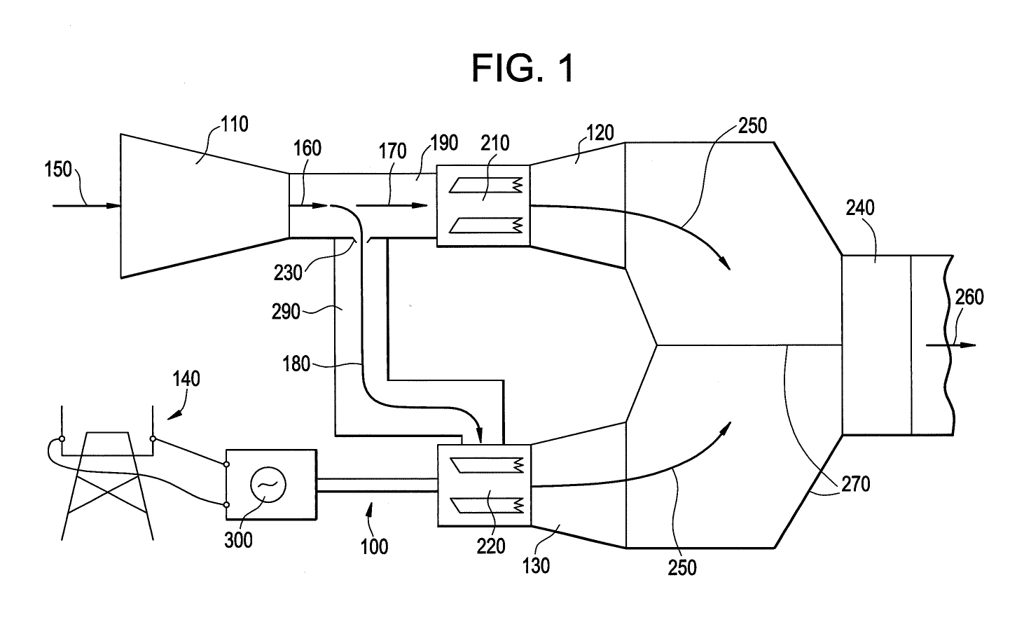

Referring to FIG. 1, an embodiment of a parallel turbine arrangement 100 is illustrated. The turbine arrangement 100 includes a single compressor 110 that feeds air to two separate turbines 120, 130. Having the two separate turbines 120, 130 operate with a single compressor 110 allows one of the turbines, turbine 120, to be in rotational sync with the compressor 110 and the other turbine 130, rotating a generator 300, to be in rotational sync with the frequency of a power grid 140. This allows the rotation of the compressor 110 and the frequency of the power grid 140 to be completely independent of one another. This decoupling of the compressor 110 from the power grid 140 allows compressor 110 and turbine 120 to operate nearer to their peak rotational efficiency regardless of conditions, such as, the frequency of the power grid 140, the ambient temperature and the density of a compressor intake fluid 150, for example.

Operating the two turbines 120, 130 with the single compressor 110 includes ducting and proportioning fluid from the compressor 110 to each of the two turbines 120, 130. The ducting and proportioning of compressed fluid flow 160 includes dividing the compressed fluid flow 160 into a plurality of streams 170, 180, running through a corresponding plurality of ducts 190. In the embodiment shown in FIG. 1, a first stream 170 feeds a first combustor 210 that in turn feeds a first turbine 120. Similarly, a second stream 180 feeds a second combustor 220 that in turn feeds a second turbine 130. The invention is not limited to a two turbine arrangement, however, and may include any number of parallel turbines. Additionally, the streams 170, 180 may have generally equal volume flow rates, or substantially different volume flow rates. It is to be understood that the volume flow rates of the streams 170, 180 may be tailored for specific applications without departing from the scope of the invention.

At least one proportioning device 230 provides an operator with the flexibility of tailoring the volume flow rate of the compressed fluid flow 160 into each of the turbines 120, 130. The proportioning device 230 divides the fluid flow 160 between the two ducts 190. The proportioning device 230 may be a valve, baffle, louver or any other mechanism for regulating volume flow rate of the compressed fluid flow 160. The parallel turbine arrangement 100 may also include any number of the proportioning devices 230 to regulate the compressed fluid flow 160 into the corresponding ducts 190.

In the embodiment herein described, the first turbine 120 is in rotational sync with the compressor 110 and provides the compressor 110 with power. Thus, the first turbine 120 is also referred to herein as a compressor turbine 120. The compressor turbine 120 is fed by the first stream 170 also referred to herein as the compressor turbine stream 170. It is to be understood, however, that the compressor turbine 120 may additionally be configured to provide power to devices other than the compressor 110. Further, the second turbine 130 is turning the generator 300 in rotational sync with the power grid 140 and provides the power grid 140 with power. Thus, the second turbine 130, also referred to herein as an output turbine 130, is fed by the second stream 180, also referred to as the output turbine stream 180. The power grid 140 includes a system for distributing electricity to consumers. However, it should be understood that the output turbine 130 might be configured to provide power to any other output source or device other than the generator 300/power grid 140 or in addition to the generator 300/power grid 140.

The foregoing adjustability of the compressor turbine stream 170 and the output turbine stream 180, among other things, allows an operator to independently configure the speed and power generation of each of the turbines 120, 130. The rotational speed of the output turbine 130 and generator 300 is fixable to a grid frequency of the power grid 140. The grid frequency is the frequency at which alternating current electricity is transmitted from a power plant to a user via the power grid 140. The power grid 140 determines the grid frequency and each power plant needs to supply power to the grid at that frequency. Embodiments disclosed herein allow the rotational speed of the compressor turbine 120 to be configured independently of the grid frequency. This decoupling allows the rotational speed of the compressor 110 and the overall power output of the parallel turbine arrangement 100 to be configured independently of the grid frequency of the power grid 140. As such, the rotational speed of the compressor 110 may be increased or decreased independently of any relationship to the grid frequency. This decoupling further allows an operator to produce constant or even increased power output from the parallel turbine arrangement 100 even during times when the grid frequency drops. This also allows for greater overall operational flexibility and efficiency of the parallel turbine arrangement 100.

Additional operational efficiencies can be gained through porting of exhaust from the two turbines 120, 130 to a heat recovery steam generator 240. The heat recovery steam generator 240 recovers heat from a combusted output stream 250 to generate steam 260 to drive a steam turbine (not shown). This combination of the parallel turbine arrangement 100 with the heat recovery steam generator 240 is referred to as a combined cycle power plant. In one embodiment, at least one of the output streams 250 includes a bypass valve 270 that is configured to allow the combusted output stream 250 to bypass the heat recovery steam generator 240. The bypass opening 270 may be a valve, baffle, louver, door or any other mechanism for regulating volume flow rate of the output stream 250.

In another embodiment, at least two of the turbines 120, 130 use common parts. For example, the two turbines 120, 130 may use a common combustor swozzle, transition piece, compressor discharge can, turbine bucket, or any other component. Using the same components enables cost savings driven by volume production. Additionally, the turbines 120, 130 may be smaller in size and thereby subjected to less operating stress than a corresponding single turbine system having the same overall power output. Centrifugal stresses on the turbine buckets (not shown) are one such load that is reduced by embodiments of the present invention.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A parallel turbine arrangement comprising:
a compressor;
a first turbine in operable communication with the compressor; and
a second turbine in operable communication with the compressor.

2. The parallel turbine arrangement of claim 1, wherein the first turbine is configured to provide power to the compressor.

3. The parallel turbine arrangement of claim 1, wherein the second turbine is configured to provide power to a generator, which provides electrical power to an electrical power grid.

4. The parallel turbine arrangement of claim 1, wherein the first turbine has a configurable first turbine operating speed and the second turbine has a configurable second turbine operating speed, the first turbine operating speed and the second turbine operating speed being independently configurable.

5. The parallel turbine arrangement of claim 4, wherein the first turbine operating speed is configurable independently of a power grid frequency.

6. The parallel turbine arrangement of claim 4, wherein the second turbine operating speed is fixable to a power grid frequency.

7. The parallel turbine arrangement of claim 1, further comprising a proportioning device for regulating an amount of flow into at least one of the first turbine and the second turbine.

8. The parallel turbine arrangement of claim 1, wherein the first turbine and the second turbine have at least one common part.

9. The parallel turbine arrangement of claim 1, wherein the compressor has a compressor operating speed, the compressor operating speed being configurable independently from a power grid frequency.

10. The parallel turbine arrangement of claim 1, further comprising a heat recovery steam generator.

11. The parallel turbine arrangement of claim 10, further comprising a actuatable valve configured to proportion a combusted output stream from at least one of the first turbine and the second turbine between the heat recovery steam generator and a bypass.

12. A method for increasing operational flexibility of a power plant comprising:
compressing fluid into a compressed fluid flow;
dividing the compressed fluid flow into a first stream and a second stream;
feeding a first turbine with the first stream; and
feeding a second turbine with the second stream.

13. The method for increasing operational flexibility of a power plant of claim 12, further comprising supplying power to the compressor with the first turbine.

14. The method for increasing operational flexibility of a power plant of claim 12, further comprising supplying power to a power grid by a generator that is powered with the second turbine.

15. The method for increasing operational flexibility of a power plant of claim 12, further comprising configuring the first turbine with a first turbine operating speed and configuring the second turbine with a second turbine operating speed, the first turbine operating speed and the second turbine operating speed being independently configurable.

16. The method for increasing operational flexibility of a power plant of claim 15, further comprising fixing the second turbine speed to a grid frequency.

17. The method for increasing operational flexibility of a power plant of claim 12, further comprising regulating an amount of fluid into at least one of the first stream and the second stream.

18. The method for increasing operational flexibility of a power plant of claim 12, further comprising configuring the compressor with a compressor operating speed independently from a grid frequency.

19. The method for increasing operational flexibility of a power plant of claim 12, further comprising supplying steam to a heat recovery steam generator.

20. A parallel turbine arrangement comprising:
a compressor having a compressor discharge flow divided into a plurality of streams, each of the plurality of streams being in operable communication with a separate turbine.
